(19) United States
(12) Patent Application Publication
(10) Pub. No.: US 2004/0190431 A1
(43) Pub. Date: Sep. 30, 2004

(54) Optical recording medium, method and apparatus for recording data thereon

(75) Inventors: Kyung-geun Lee, Gyeonggi-do (KR); Yong-jin Ahn, Seoul (KR); Wook-yeon Hwang, Gyeonggi-do (KR); Du-seop Yoon, Gyeonggi-do (KR); In-sik Park, Gyeonggi-do (KR); Seong-sue Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon -si (KR)

(21) Appl. No.: 10/751,731

(22) Filed: Jan. 6, 2004

(30) Foreign Application Priority Data
Jan. 23, 2003 (KR) 2003-4547
Jun. 14, 2003 (KR) 2003-38520

(51) Int. Cl. G11B 7/24

(52) U.S. Cl. 369/275.1

(57) ABSTRACT

An optical recording medium, a method and an apparatus of recording data on the optical recording medium. A recording waveform that includes a recording pattern for high-speed recording and an erasure pattern with multi-pulse train is generated. Using the generated recording waveform, digital data is recorded as a mark or space. A low write power level of the recording pattern is set to be higher than a bias power level, and high and low erase power levels are applied as pulses.

### CROSS-REFERENCE TO RELATED APPLICATIONS

This application claims the priority of Korean Patent Application No. 2003-4547, filed Jan. 23, 2003, and Korean Patent Application No. 2003-38520, filed on Jun. 14, 2003, in the Korean Intellectual Property Office, the disclosures of which are incorporated herein in their entirety by reference.

### BACKGROUND OF THE INVENTION

1. Field of the Invention

The present invention relates to recording data onto optical recording media, and more particularly, to an optical recording medium that stores information related to a writing strategy for high-speed recording, and a method and an apparatus for recording data thereon.

2. Description of the Related Art

When data is recorded on an optical recording medium, marks are formed in tracks of the optical disc. In read only discs such as compact disc read only memories (CD-ROMs) and digital versatile disc—read only memories (DVD-ROMs), the marks are formed as pits. In recordable discs such as compact discs—recordable/rewritable (CD-R/RW) and digital versatile discs—recordable/rewritable/random access memories (DVD-R/RW/RAM), a recording layer is coated with a phase change layer that enters a crystalline or non-crystalline state in response to changes in temperature, and the marks are formed by changes in phase of the phase change layer. In order to optimize the recording/reproducing characteristics of the recordable discs, a writing strategy has been introduced and is dependent on a type of recordable discs. Also, recording conditions may vary from drive to drive. Therefore, there may be cases where an optical recording medium recorded on one drive may not be compatible with another.

Meanwhile, in terms of signal detection, data recording methods can be classified into mark edge recording and mark position recording. In the mark position recording method, the amplitude of a detected RF signal changes from positive to negative or from negative to positive at the recording position of a mark. In the mark edge recording method, the amplitude of the detected RF signal changes from positive to negative or from negative to positive at both edges of a mark. Consequently, accurate recording of edges of a mark is an important factor in improving the quality of reproduced signals.

However, in recordable discs where the recording layer is coated with the phase change layer, the shape of the trailing edge of the mark recorded by a conventional mark edge recording method varies with the length of a mark or a space between marks. In other words, the trailing edge of a mark is larger than the leading edge of the mark, which degrades recording/reproducing characteristics. When the length of the formed mark is relatively large, degradation of recording/reproducing characteristics becomes more serious due to a buildup of heat in the disc.

FIGS. 1A and 1B illustrate a conventional recording waveform which is used to record non- return to zero inverted (NRZI) data. In FIG. 1A, ‘Tw’ denotes a time period of a recording/reproducing clock signal. In the mark edge recording method, a high level of NRZI data is recorded as a mark and a low level of NRZI data is recorded as a space. The recording waveform used to form a mark is referred to as a recording pattern, and the recording waveform used to form a space (or used to erase a mark) is referred to as an erasure pattern. The conventional recording waveform uses a multi-pulse train as a recording pattern and adjusts the power level of each pulse to three levels, i.e., Pw, Pe, and Pb. In other words, the power levels of a multi-pulse train constituting the recording pattern are equal to Pw and Pb. Also, the power level Pe of the erasure pattern, which is used to form the low level of NRZI data, i.e., the space, is maintained at a predetermined DC level. Here, Pw denotes write power, Pb denotes bias power, and Pe denotes erase power.

As described above, since the erasure pattern in the conventional recording waveform is maintained at the predetermined DC level for a predetermined amount of time, a temperature of 0-200° C. is continuously applied to the zone to which the erasure pattern is applied. Consequently, if data recording is repeated a number of times, distortions of the shape of a mark are caused, degrading recording/reproducing characteristics. Thus, with the introduction of high-density and high-speed linear recording devices which hold more data, the time period T of the recording/reproducing clock signal decreases, and thermal interference between multi-pulse trains constituting the recording waveform increases. As a result, distortions of the shape of a mark become more serious.

In other words, since erasing is performed using an erase power having a predetermined DC level during data recording, recording/reproducing signals such as carrier to noise ratio (C/N) signals are reduced due to thermal interference between multiple recording pulses and a mark is incompletely formed and then crystallized, causing degradation of the reproducing characteristics. In particular, when data recording is performed at high speed to increase the data transmission speed, distortion of the recording/reproducing signals remarkably increases.

### SUMMARY OF THE INVENTION

The present invention provides an optical recording medium that stores information related to a writing strategy for high-speed recording and a method and an apparatus for recording data thereon.

The present invention also provides an optical recording medium that stores information related to a recording waveform, by which a mark with improved edges can be recorded during high-speed recording, and a method and an apparatus for recording data using the recording waveform.

The present invention also provides an optical recording medium that stores information related to a recording waveform for phase-change optical discs and a method and an apparatus for recording data using the recording waveform.

The present invention also provides an optical recording medium that stores information related to a recording waveform, by which distortion of a recorded mark due to thermal interference between adjacent marks during mark edge recording can be minimized, and a method and an apparatus for recording data using the recording waveform.

The present invention also provides an optical recording medium that stores information regarding a recording waveform, by which shape distortion of the leading and trailing edges of a mark due to repetitive recording can be suppressed, and a method and an apparatus for recording data using the recording waveform.

The present invention also provides an optical recording medium to which additional information regarding a recording pattern used to form a mark and/or an erasure pattern used to form a space is recorded, thereby allowing an optimal power level required for data recording to be easily determined irrespective of a drive into which the optical recording medium is loaded, and a method and an apparatus for recording data thereon.

The present invention also provides an optical recording medium that stores information related to a recording waveform for optimising jitter characteristics, and a method and an apparatus for recording data using the recording waveform.

The present invention also provides an optical recording medium that stores information related to a ratio of the time duration of a multi-pulse train to the time duration of the last pulse among a recording waveform for minimizing jitter characteristics, and a method and an apparatus for recording data using the recording waveform.

The present invention also provides an optical recording medium that stores information related to cooling time duration of the last pulse among a recording waveform for minimizing jitter characteristics, and a method and an apparatus for recording data using the recording waveform.

According to one aspect of the present invention, there is provided an optical recording medium which can record, erase, and reproduce data, wherein additional recording information including power information for high-speed recording of a recording pattern for data recording is recorded at a specific zone of a recording layer.

According to one aspect of the present invention, there is provided an optical recording medium on which power information is recorded, the power information indicating that the recording pattern is formed of recording multi-pulse trains including a first pulse, a multi-pulse train and/or a last pulse, wherein the recording multi-pulse trains have high and low write power levels, and the low write power level is set to be higher than a bias power level.

According to another aspect of the present invention, there is provided a method of recording data onto an optical recording medium, the method comprising generating a recording waveform having a recording pattern for high-speed recording and forming a first level of the data as a mark and a second level of the data as a space, using the generated recording waveform.

According to yet another aspect of the present invention, there is provided a method of recording data onto an optical recording medium, the method comprising generating a recording waveform having a recording pattern and an erasure pattern with multi-pulse train for high-speed recording and forming a first level of the data as a mark and a second level of the data as a space, using the generated recording waveform.

According to yet another aspect of the present invention, there is provided an apparatus of recording data onto an optical recording medium comprising a recording waveform generating unit and a pickup unit. The recording waveform generating circuit generates a recording waveform having a recording pattern for high-speed recording of input data. The pickup unit forms a mark or space by irradiating light onto the optical recording medium according to the generated recording waveform to record the data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates non-return to zero inverted (NRZI) data and FIG. 1B illustrates a conventional recording waveform;

FIG. 2 is a block diagram of an apparatus which records data according to an embodiment of the present invention;

FIG. 3 is an example of FIG. 2;

FIGS. 4A through 7D illustrate examples of recording waveforms generated by a recording waveform generating circuit;

FIGS. 8A through 8E illustrate waveforms for explaining 4 types of erasure patterns according to the present invention;

FIGS. 9A through 9D illustrate waveforms for reducing jitter according to the present invention;

FIG. 10 is a graph showing the relationship between jitter and recording power with respect to the ratio of the time duration a of multi-pulse train to the time duration of the last pulse in the recording waveform of FIG. 9;

FIG. 11 is a graph showing the relationship between jitter and cooling time duration of the last pulse in the recording waveform of FIG. 9; and

FIG. 12 is a flowchart for explaining a method of recording data according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

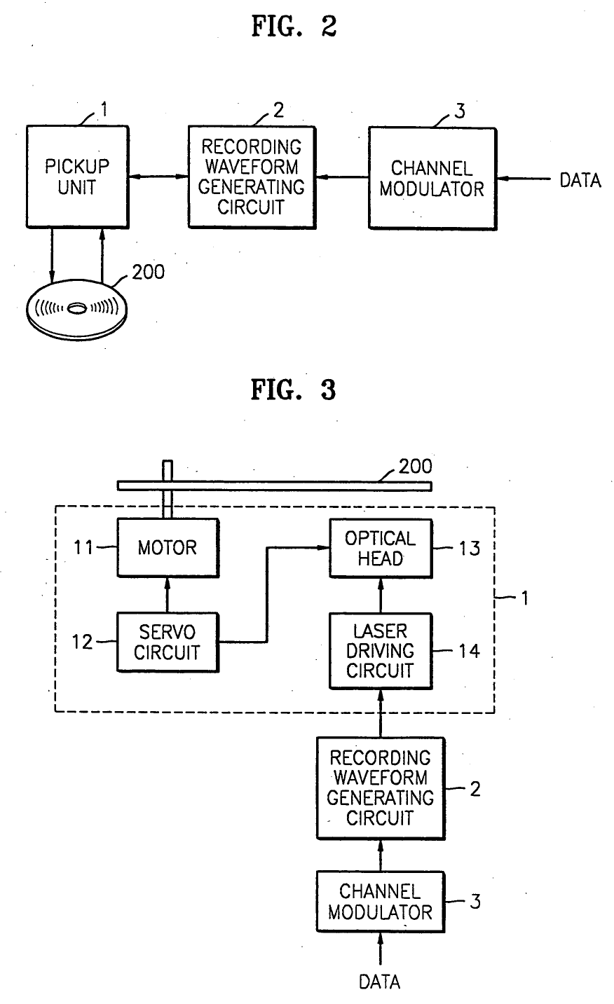

FIG. 2 is a block diagram of an apparatus for recording data according to an embodiment of the present invention.

Referring to FIG. 2, the apparatus for recording data records data by forming a mark or space in an optical recording medium 200 and includes a pickup unit 1, a recording waveform generating circuit 2, and a channel modulator 3.

The channel modulator 3 modulates externally input data into a channel bit stream. The recording waveform generating circuit 2 receives the channel bit stream and generates a recording waveform. The generated recording waveform according to the present invention includes a recording pattern for high-speed recording and an erasure pattern having an erase multi-pulse train. The recording waveform will be described in detail later. The pickup unit 1 forms a mark or space by irradiating light onto the optical recording medium 200 according to the generated recording waveform.

FIG. 3 is an example of FIG. 2. Blocks that implement the same functions as those of FIG. 2 are represented by the same references, and descriptions thereof will not be repeated.

Referring to FIG. 3, the apparatus for recording data includes the pickup unit 1, the recording waveform generating circuit 2, and the channel modulator 3. The pickup unit 1 includes a motor 11, a servo circuit 12, an optical head 13, and a laser driving circuit 14. The motor 11 rotates the optical recording medium 200. The optical head 13 irradiates laser light onto the optical recording medium 200 or receives laser light reflected off the optical recording medium 200. The servo circuit 12 performs servo control of the motor 11 and the optical head 13. The laser driving circuit 14 drives a laser (not shown) included in the optical head 13.

The channel modulator 3 modulates input data into a channel bit stream and outputs non-return to zero inverted (NRZI) data. The recording waveform generating circuit 2 generates a recording waveform for recording the NRZI data and provides the generated recording waveform to the laser driving circuit 14 included in the pickup unit 1. The laser driving circuit 14 forms marks or spaces in the optical recording medium 200 by controlling the laser (not shown) of the optical head 13 according to the received recording waveform.

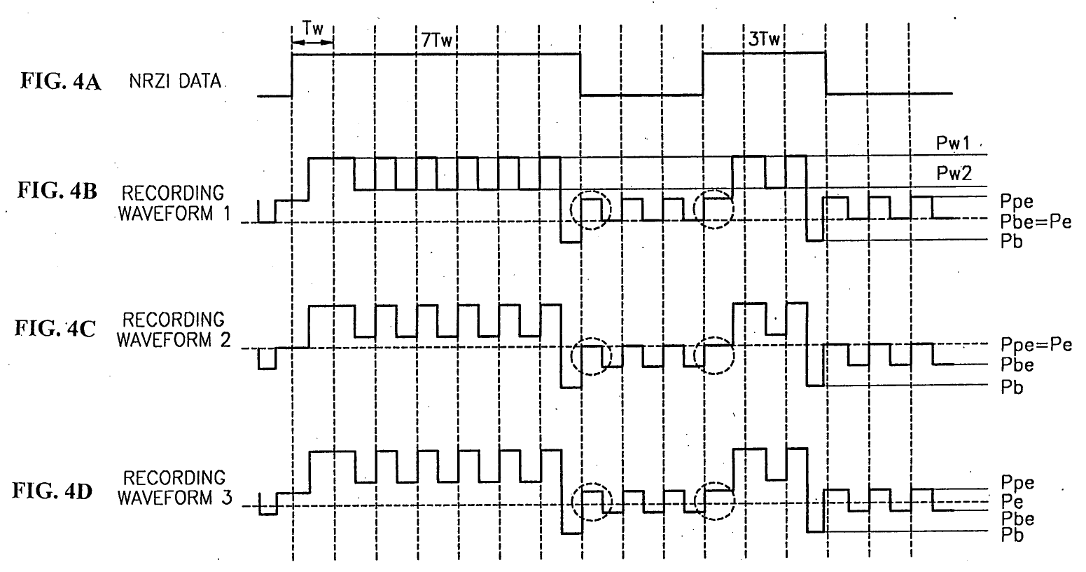

FIGS. 4A through 4D illustrate recording waveforms that are generated by the recording waveform generating circuit 2 and intended to improve the edge characteristics of a mark during data recording.

The NRZI data varies with a modulation method used by the channel modulator 3. When Run Length Limited (RLL) (1,7) is used as a modulation method, the minimum length of a recorded mark is equal to 2T and the maximum length of a recorded mark is equal to 8T. In addition, RLL (2,10), i.e., Eight to Fourteen Modulation (EFM), Eight to Fourteen Modulation plus (EFM+), D (8-15), or dual modulation is used as a modulation method, the minimum length of the recorded mark is equal to 3T and the minimum length of the recorded mark is equal to 1T. Here, Matsushita Electric Co., Ltd., proposed D(8-15) in “Optical disc recording system of 25GB Capacity” in 2001. Dual modulation was disclosed in Korean Patent Application No. 99-42032, titled “Method of aligning RLL code with improved DC restricting function, encoding and decoding method and decoding apparatus”, which was filed on Sep. 30, 1999 by the present applicant and published on Nov. 25, 2000.

In this embodiment, recording waveforms used when a high level of the NRZI data is formed as a mark, and a low level of the NRZI data is formed as a space, will be described in relation to NRZI data that includes a recording pattern for recording a mark having a length of 7T, an erasure pattern for forming a space having a length of 3T, and a recording pattern for recording a mark having a length of 3T.

Referring to FIGS. 4B through 4D, in recording waveforms 1, 2, and 3 for the NRZI data, a recording pattern for recording a mark having a length of 7 Tw is formed of a recording multi-pulse train, i.e., a first pulse, a multi-pulse train, and a last pulse (or cooling pulse). The recording pattern for recording a mark having a length of 3T is formed of a first pulse and a last pulse. In FIG. 4, when a mark having multi-pulse train of N×Tw (where N is a natural number) is formed, a recording pattern having recording pulses of (N−1)×Tw is used with respect to a mark whose length ranges from the minimum T to the maximum T. In other words, a mark having a length of 3T is formed using a recording pattern including 2 multi-pulse trains, and a mark having a length of 7T is formed using a recording pattern including 6 multi-pulse trains.

The first pulse of the recording pattern and the multi-pulse train have two power levels, i.e., Pw1 and Pw2. Here, Pw1 denotes a high level of write power, and Pw2 denotes a low write power level. The low write power level, i.e., Pw2 is set to be higher than bias power level Pb. The last pulse of the recording pattern has the high write power level, i.e., Pw1, and the bias power level Pb.

Since the total power provided to record a mark decreases when data is recorded at high speed to increase data transmission speed (that is, when the time period T of the recording/reproducing clock signal decreases), the shape of a recorded mark may be distorted. Thus, it is necessary to increase the write power as the rotation speed of a disc increases. By setting the low write power level Pw2 higher than the bias power level Pb, a recording layer can absorb sufficient heat even at a high data recording speed, which makes it possible to form a mark in the recording layer.

The erasure pattern is also formed of a multi-pulse train. That is, although the erasure pattern according to this embodiment may have a conventional DC level, it is preferably formed of an erase multi-pulse train. The erase multi-pulse train has two power levels, Ppe and Pbe. Here, the power level Ppe denotes a peak erase power level and can be referred to as a high erase power level, and the power level Pbe denotes a bias erase power level and can be referred to as a low erase power level.

In recording waveform 1, the bias erase power level Pbe of the erasure pattern is equal to the erase power level Pe of a conventional DC level. In recording waveform 2, the peak erase power level Ppe of the erasure pattern is equal to the erase power level Pe. In recording waveform 3, the erase power level Pe is set between the peak erase power level Ppe of the erasure pattern and the bias erase power level Pbe.

The sum of time durations of the two power levels Ppe and Pbe of the erase multi-pulse train included in the erasure pattern of the present invention with respect to a timing window Tw (a period of a reference recording/reproducing clock signal) is controlled within a range of 0.25-2.0 Tw. Thus, data can be recorded by selecting a time duration of two power levels Ppe and Pbe, suitable for thermal characteristics of a disc, thereby improving recording/reproducing characteristics.

In the embodiment of FIGS. 4B through 4D, the sum of time durations of power levels Ppe and Pbe of the erase multi-pulse train for forming a mark having a length of 3T is equal to 1.0 Tw. The time duration of the high level of the first pulse of the erase multi-pulse train is equal to 0.5 Tw, and the time duration of the high level of the last pulse of the erase multi-pulse train may be larger than 0.5 Tw.

In addition, in the embodiment of FIG. 4B, the time period T of the multi-pulse train of the recording pattern is equal to 1.0 Tw. The low write power level Pw2 is higher than the bias power level Pb and the peak erase power level Ppe and lower than the high write power level Pw1. Thus, the relationship among the peak erase power Ppe, the low write power level Pw2, and the high write power level Pw1 is Ppe≦Pw2≦Pw1. Here, the low write power level Pw2 may be lower than the peak erase power level Ppe of the erasure pattern and higher than the bias erase power level Pbe, and thus their relationship may be Pbe≦Pw2≦Ppe. Also, the low write power level Pw2 is lower than the bias erase power level Pbe, and their relationship may be Pbe≧Pw2. A level of a zone affected by the bias power level Pb is lower than the low write power level Pw2, and their relationship is Pb≦Pw2. The level of a zone affected by the bias power Pb is lower than the peak erase power level Ppe, and their relationship is Pb≦Ppe.

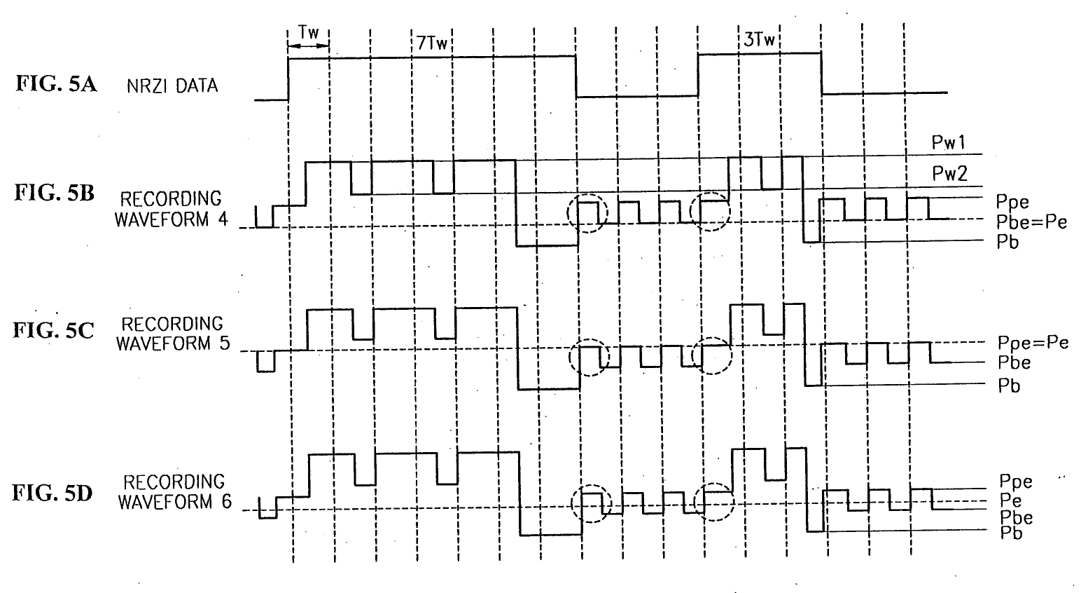

FIG. 5A illustrates non-return to zero inverted (NRZI) data. FIGS. 5B through 5D illustrate recording waveforms generated by the recording waveform generating circuit 2, in which the number of multi-pulse train in each recording pattern is int (N/2×T). Only the difference between the recording waveforms of FIGS. 4B through 4D will be described with reference to FIGS. 5B through 5D. The term “int” denotes an integer.

Referring to FIGS. 5B through 5D, since the time period T of the multi-pulse train of the recording pattern is 2 Tw in three recording waveforms 4, 5, and 6 for the NRZI data, a quality mark can be formed by increasing the amount of incident light of a disc without increasing the write power and the erase power, thereby improving recording/reproducing characteristics. In case of a mark having signal type of T or 3T, the time period T of the multi-pulse train may not be 2 Tw.

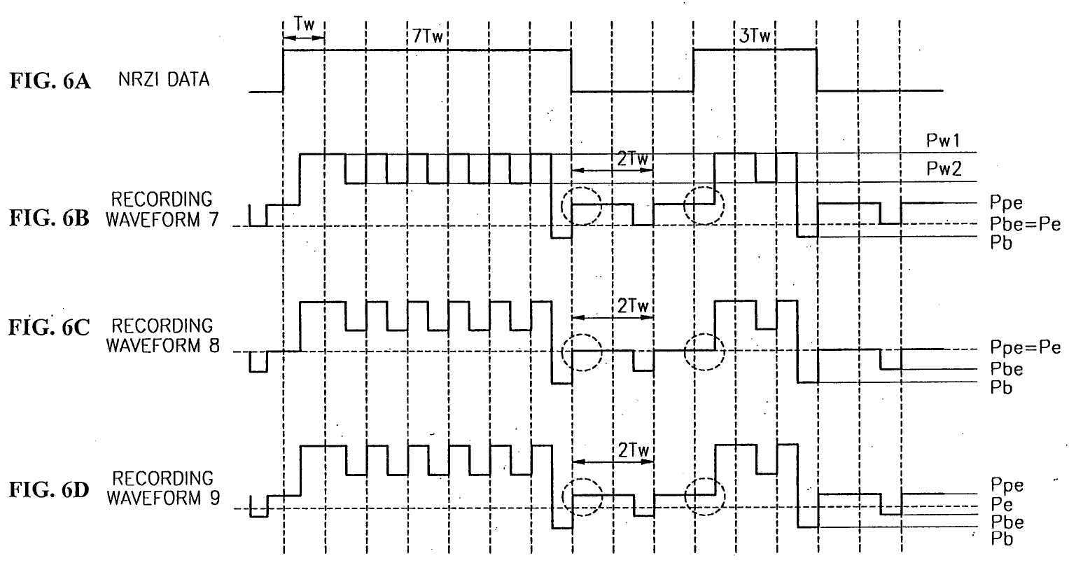

FIG. 6A illustrates non-return to zero inverted (NRZI) data. FIGS. 6B through 6D illustrate recording waveforms generated by the recording waveform generating circuit 2, in which the time duration of power levels of the erase multi-pulse train is equal to 2 Tw. With respect to FIGS. 6B through 6D, only the difference between the recording waveforms of FIGS. 4B through 4D will be described.

Referring to FIGS. 6B through 6D, in three recording waveforms 7, 8, and 9 for the NRZI data, the sum of time durations of the peak erase power level Ppe of the erase multi-pulse train forming the erasure pattern and the bias erase power level Pbe of the erase multi-pulse train forming the erasure pattern is equal to 2 Tw. The time duration of the high level of the erase multi-pulse train may be longer than 1.0 Tw, and the time duration of the low level of the erase multi-pulse train may be shorter than 1.0 Tw.

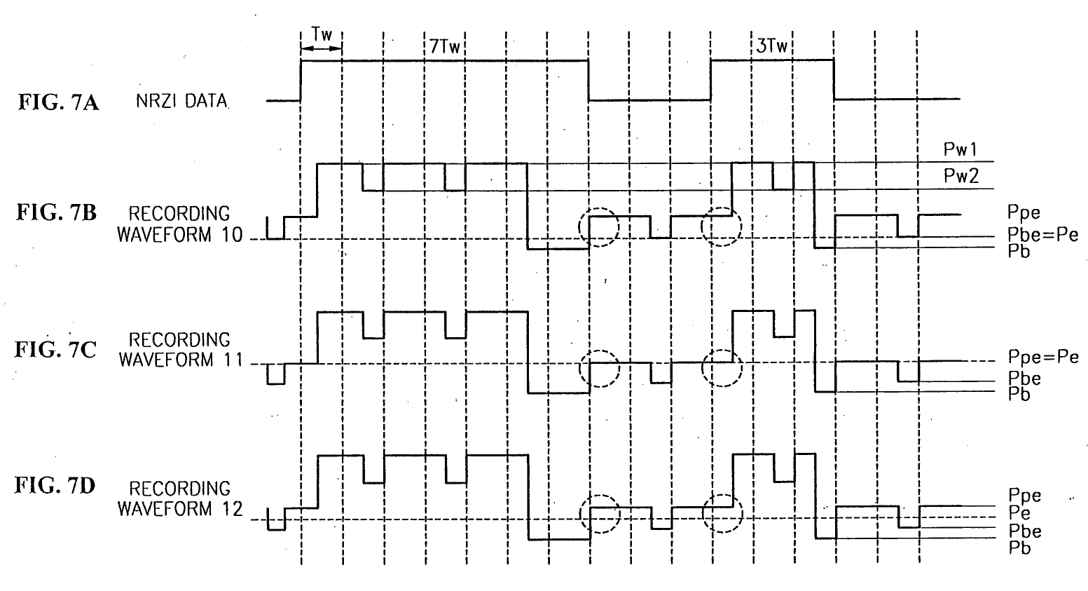

FIG. 7A illustrates non-return to zero inverted (NRZI) data. FIGS. 7B through 7D illustrate recording waveforms generated by the recording waveform generating circuit 2, in which time duration of a level of the multi-pulse train of the recording pattern and time duration of a level of the erasure pattern are 2 Tw. With respect to FIGS. 7B through 7D, only the difference between the recording waveforms of FIGS. 4B through 4D will be described.

Referring to FIGS. 7B through 7D, in three recording waveforms 10, 11, and 12 for the NRZI data, the time period T of the multi-pulse train of the recording pattern is equal to 2 Tw, and the time period T of the multi-pulse train of the erasure pattern is equal to 2 Tw. In the same manner as the recording waveforms of FIGS. 6B through 6D, the sum of time durations of the peak erase power level Ppe and the bias erase power level Pbe is equal to 2 Tw.

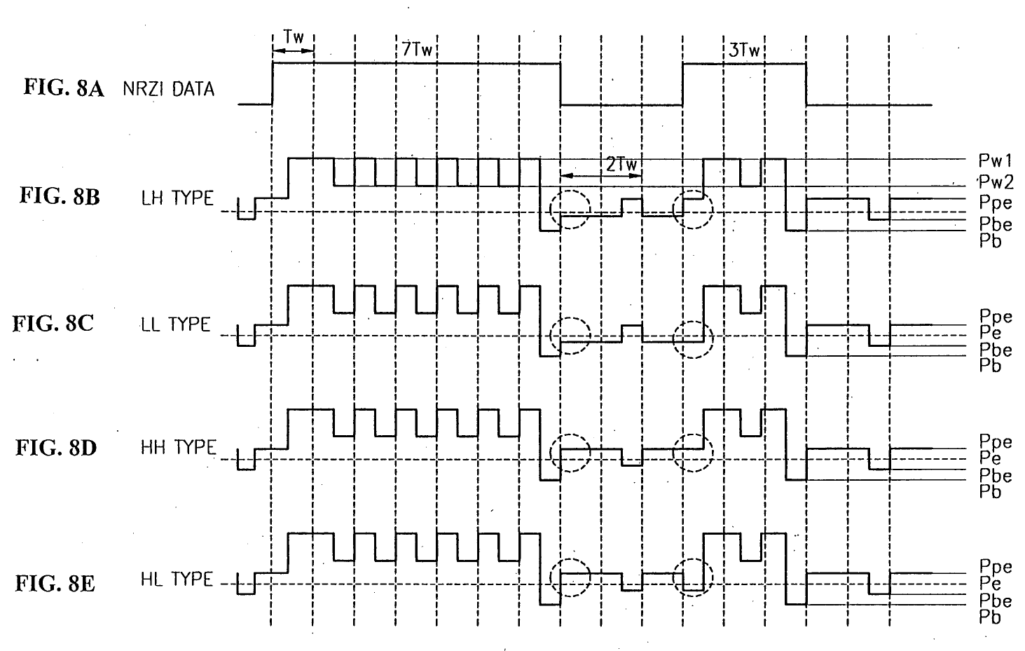

FIG. 8A illustrates non-return to zero inverted (NRZI) data. FIGS. 8B through 8E illustrate waveforms for explaining 4 types of erasure patterns according to the present invention.

Referring to FIGS. 8B through 8E, recording waveforms according to the present invention may have 4 types of erasure patterns, i.e., an LH type, an LL type, an HH type, and an HL type. Differences among 4 types of erasure patterns are marked by circles in FIGS. 8B through 8D to facilitate understanding. First, the LH type corresponds to a case where the power level of the first pulse is equal to the low level present in the erasure pattern, and the power level of the last pulse is equal to the high level present in the erasure pattern. The LL type corresponds to a case where the power levels of the last pulse and first pulse are equal to the low level present in the erasure pattern. The HH type corresponds to a case where the power levels of the last pulse and first pulse are equal to the high level present in the erasure pattern. The HL type corresponds to a case where the power level of the last pulse is equal to the low level present in the erasure pattern, and the power level of the first pulse is equal to the high level present in the erasure pattern.

In the embodiments of FIGS. 8B through 8E, the time period T of the multi-pulse train of the recording pattern is equal to 1 Tw, and the time period T of the multi-pulse train of the erasure pattern is equal to 2 Tw as in the recording waveforms 7, 8, and 9 of FIGS. 6B through 6D. However, the embodiment of FIGS. 8B through 8E is also applicable to FIGS. 4B through 4D showing the recording waveforms 1, 2, and 3 where the time period T of the multi-pulse train of the recording pattern and the time period T of the multi-pulse train of the erasure pattern are equal to 1 Tw. The embodiments of FIGS. 8B through 8E are also applicable to FIGS. 5B through 5D showing the recording waveforms 4, 5, and 6 where the time period T of multi-pulse train of the recording pattern is equal to 2 Tw and the time period T of the multi-pulse train of the erasure pattern is equal to 1 Tw. The embodiments of FIG. 8B through 8E are also applicable to FIGS. 7B through 7D showing the recording waveforms 10, 11, and 12 where the time period T of multi-pulse train of the recording pattern and the time period T of multi-pulse train of the erasure pattern are equal to 2 Tw.

That is, all of the recording waveforms shown in FIGS. 4B through 7D are of the HH type. However, the recording waveforms may be of the HL type, the LH type, or the LL type. The type of recording waveforms is determined based on the length of the mark formed by the recording pattern that is present before and/or after the erasure pattern. One type of erasure pattern is adaptively selected from among 4 types of erasure patterns based on the length of the mark formed before and/or after the space formed by the erasure pattern.

Meanwhile, information about the 4 types of erasure patterns (type information) can be recorded at a specific zone of a recordable disc, e.g., a lead-in zone, or recorded as header information in the form of wobble signals. Thus, the recording medium can read type information from the lead-in zone or the wobble signal during data recording and generate corresponding recording waveforms, thus forming a mark and/or space.

Furthermore, the 4 types of erasure patterns can be used as symbols indicating the operating speed of the disc or the type of the mark in data recording and reproducing. For example, it is possible to indicate that a disc using the erasure pattern of LH type has the operating speed of ×20 using a type of erasure patterns.

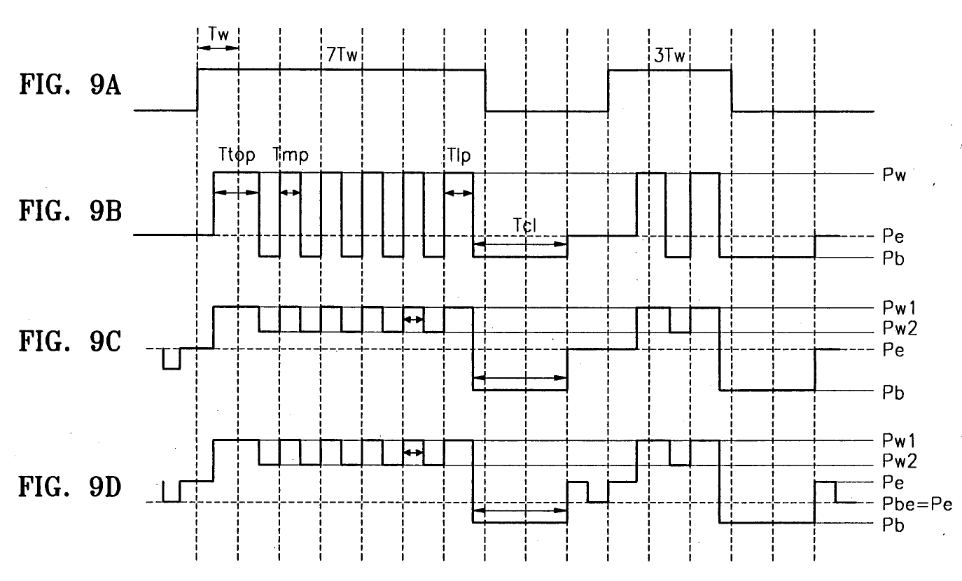

In addition to information about the 4 types of erasure patterns, information about write powers according to the recording pattern, erase powers according to the erasure pattern, a disc type, a disc size, and a type of recording layers, e.g., a single layer or a multi-layer, can be recorded to an optical recording medium. In particular, information of a recording pattern including a ratio of time duration of multi-pulse train to time duration of the last pulse among recording pulses for optimizing jitter characteristics shown in FIGS. 9A through 9D and cooling time duration of the last pulse can be recorded to the optical recording medium.

Once such an optical recording medium to which the above-described information is recorded is loaded onto an apparatus of recording data, the apparatus for recording data needs no additional test recording for selecting optimal recording and erase powers or may perform test recording with stored powers. Thus, it is possible to reduce time needed for selecting optimal power levels.

FIGS. 9A through 9D illustrate recording waveforms for reducing jitter according to the present invention.

FIG. 9A shows an example of NRZI data. When a high level of NRZI data is formed as a mark and a low level of NRZI data is formed as a space, a recording waveform includes a recording pattern for recording a mark having a length of 7T, an erasure pattern for forming a space having a length of 3T, and a recording pattern for recording a mark having a length of 3T.

FIG. 9B illustrates a typical recording waveform for NRZI data shown in FIG. 9A. Ttop denotes time duration of the first pulse, Tmp denotes time duration of each pulse included in a multi-pulse train (hereinafter, referred to as time duration of multi-pulse train), Tlp denotes time duration of the last pulse, and Tcl denotes cooling time duration of the last pulse.

FIG. 9C illustrates a recording waveform according to the present invention. The power levels of the first pulse and the multi-pulse train are Pw1 and Pw2. The low write power level, i.e., Pw2 is set to be higher than the bias power level Pb. The last pulse of the recording pattern has the high write power level Pw1 and the bias power level Pb. The erasure pattern has a conventional DC level.

FIG. 9D illustrates a recording waveform according to the present invention. The power levels of the first pulse and the multi-pulse train are Pw1 and Pw2. The low write power level, i.e., Pw2 is set to be higher than the bias power level Pb. The last pulse of the recording pattern has the high write power level Pw1 and the bias power level Pb. The erasure pattern has the peak erasure power Ppe and the erasure multi-pulse train of the bias erasure power level Pbe. The bias erasure power level Pbe of the erasure pattern is set to be equal to the erasure power level Pe of the conventional DC level. The sum of the time duration of Ppe and Pbe is equal to 1.0 Tw.

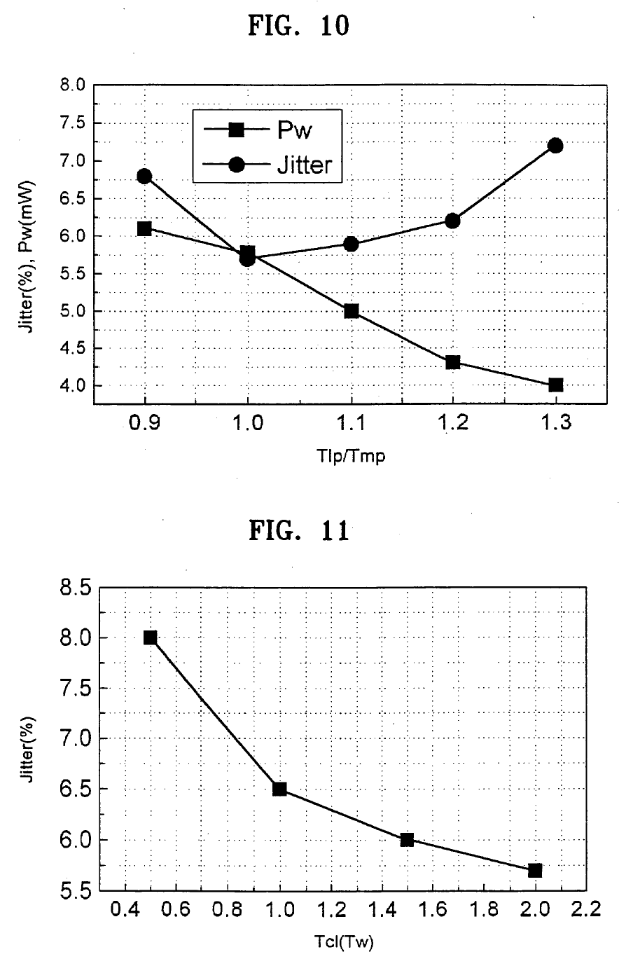

In relation to the recording waveforms of FIGS. 9C and 9D according to the present invention, a graph showing jitter characteristics obtained by changing time duration Tmp of the multi-pulse train and time duration Tlp of the last pulse and searching for the optimal recording condition is illustrated in FIG. 10. A graph showing jitter characteristics obtained by changing cooling time duration Tcl of the last pulse and searching for the optimal recording condition is illustrated in FIG. 11.

FIG. 10 is a graph showing the relationship between jitter and a recording power with respect to a ratio of time duration of multi-pulse train to time duration of the last pulse in the recording waveform of FIG. 9. According to the recording condition, the length of the minimum recorded mark is 0.149 μm at a wavelength of 400 nm (the length corresponds to the minimum recorded mark of 2 Tw when a code according to RLL (1,7) is used). When the bias power Pb is 0.2 mW and the erasure power Pe is 1.2 mW, the write power Pw decreases as the ratio of Tip to Tmp increases, but increases in relation to jitter. As is evident from this result, it is possible to obtain an appropriate range of Tlp.

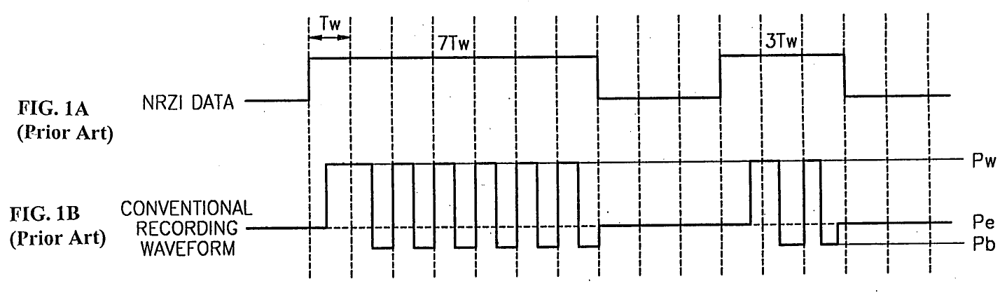

As is implied in FIG. 10, when a range of jitter that is allowable by a system is set to 7%, a range of Tlp/Tmp corresponds to 0.9-1.3. Although not shown in FIG. 1 0, when the range of jitter is 8%, the range of Tlp/Tmp corresponds to 0.7-1.4. Thus, the range of Tlp/Tmp can be determined according to the range jitter allowable by the system.

FIG. 11 is a graph showing the relationship between jitter and cooling time duration of the last pulse in the recording waveform of FIG. 9. When jitter is estimated while changing cooling time duration Tcl of the last pulse, it is can be seen that jitter continuously decreases as cooling time duration Tcl of the last pulse approaches the minimum recorded mark of 2 Tw. Considering jitter characteristics, the most preferable Tcl is equal to the minimum recorded mark of 2 Tw.

However, it is possible to set the cooling time duration Tcl of the last pulse according to the range of jitter allowable by the system. For example, when the range of jitter allowable by the system is 7%, cooling time duration Tcl of the last pulse ranges 0.7 Tw-2.0 Tw. When the range of jitter allowable by the system is 8%, cooling time duration Tcl of the last pulse ranges from 0.5 Tw-2.0 Tw. Here, the minimum Tcl depends on the range of jitter allowable by the system, and the maximum Tcl depends on the length of the minimum recorded mark.

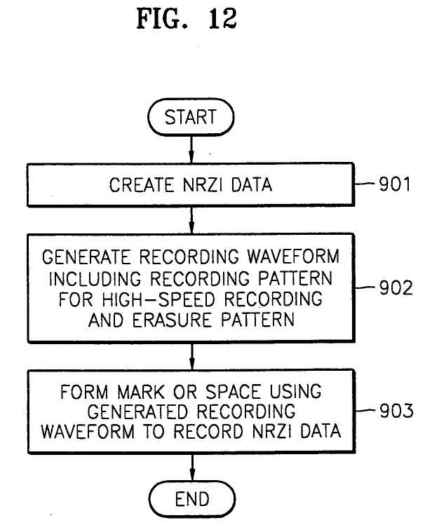

Based on configurations described above, a method of recording data according to an aspect of the present invention will be described with reference to FIG. 12.

FIG. 12 is a flowchart for explaining a method of recording data according to an embodiment of the present invention.

Referring to FIG. 12, the apparatus of recording data receives data from outside, modulates the received data, and creates NRZI data (operation 901). Next, a recording waveform having a recording pattern and an erasure pattern with multi-pulse train is generated for high-speed recording and improves mark edge characteristics (operation 902). Here, a low level of write power of the present invention is higher than bias power level. Then, a mark or space is formed in an optical disc using the generated recording waveform (operation 903).

The recording waveforms are described with respect to signal type 7T and 3T here. However, those skilled in the art can easily generate the recording pattern and the erasure pattern for forming the mark and the space with respect to 2T, 4-6T, and 8-maximum T.

In addition, when a mark having a multi-pulse train of N×Tw of the recording pattern is formed (where N is a natural number), it is possible to improve recording/reproducing characteristics by applying an embodiment of the present invention to not only a recording method where recording pulses of (N−1)×Tw are used for forming a mark whose length is T but also to a recording method such as a recording method of DVD-RAM where recording pulses of (N−2)×Tw are used for forming a mark whose length is T.

As described above, according to the present invention, a low level of write power for a recording pattern is set to be higher than a bias power level when data is recorded. Thus, a recording layer can absorb sufficient heat even when data is recorded at high speed, thereby efficiently improving edge characteristics of a recorded mark.

In addition, according to the present invention, shapes of leading and trailing parts of a mark are prevented from being distorted because the mark is recorded by applying the erase power level to a disc in the shape of pulses, thereby improving recording/reproducing characteristics.

In the present invention, time durations of high and low levels of the erase power are controlled with respect to a timing window Tw within a range of 0.25-2.0 Tw, and data is recorded onto a disc while selecting time durations of high and low levels of the erase power that are suitable for thermal characteristics of the disc, thereby improving recording/reproducing characteristics.

In addition, when time periods of a recording multi-pulse train and an erase multi-pulse train are equal to 2.0 Tw, respectively, it is possible to form a quality mark by increasing the amount of incident light of a disc, without increasing the write power and erase power, thereby improving recording/reproducing characteristics.

Also, by setting an appropriate ratio of time duration of the last pulse of the recording waveform to a time duration of a multi-pulse train of the recording waveform, it is possible to obtain proper jitter characteristics, thereby improving recording/reproducing characteristics.

Furthermore, by reducing the cooling time duration of the last pulse of the recording waveform within a predetermined range, it is possible to obtain the optimal jitter characteristics, thereby improving recording/reproducing characteristics.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical recording medium recording, erasing, and reproducing data, comprising a recording layer having a specific zone in which additional recording information, including power information for high-speed recording of a recording pattern for data recording.

2. The optical recording medium of claim 1 wherein the power information indicates that a recording pattern is formed of a recording multi-pulse train including a first pulse, a multi-pulse train and/or a last pulse, wherein the recording multi-pulse train has high and low write power levels, and the low write power level is set to be higher than a bias power level.

3. The optical recording medium of claim 2, wherein an erasure pattern formed of an erase multi-pulse train for data erasure is recorded, and the power information indicates that the erase multi-pulse train has high and low erase power levels and the low erase power level is set to be equal to a predetermined DC level of a general erase power, and the high erase power level is equal to the predetermined DC level, or the predetermined DC level is between the high erase power level and the low erase power level.

4. The optical recording medium of claim 3, wherein a ratio of a time duration of the last pulse to a time duration of the multi-pulse train has a predetermined range with respect to a range of jitter allowable by a system.

5. The optical recording medium of claim 4, wherein when the range of jitter allowable by the system is 7%, the ratio of the time duration of the last pulse to the time duration of the multi-pulse train ranges from 0.9 to 1.3.

6. The optical recording medium of claim 4, wherein when the range of jitter allowable by the system is 8%, the ratio of the time duration of the last pulse to the time duration of the multi-pulse train ranges from 0.7 to 1.4.

7. The optical recording medium of claim 3, wherein s minimum cooling time duration of the last pulse depends on the range of jitter allowable by a system, and a maximum cooling time duration of the last pulse depends on a length of a minimum recorded mark.

8. The optical recording medium of claim 7, wherein the cooling time duration of the last pulse of the recording pattern is set to the length of the minimum recorded mark.

9. The optical recording medium of claim 2, wherein a power for the erasure pattern for data erasure has a predetermined DC level.

10. The optical recording medium of claim 9, wherein a ratio of a time duration of the last pulse to a time duration of the multi-pulse train has a predetermined range with respect to a range of jitter allowable by a system.

11. The optical recording medium of claim 10, wherein when the range of jitter allowable by the system is 7%, the ratio of the time duration of the last pulse to the time duration of the multi-pulse train ranges from 0.9 to 1.3.

12. The optical recording medium of claim 10, wherein when the range of jitter allowable by a system is 8%, the ratio of the time duration of the last pulse to the time duration of multi-pulse train ranges from 0.7 to 1.4.

13. The optical recording medium of claim 9, wherein the minimum cooling time duration of the last pulse depends on the range of jitter allowable by a system, and the maximum cooling time duration of the last pulse depends on a length of a minimum recorded mark.

14. The optical recording medium of claim 7, wherein the cooling time duration of the last pulse of the recording pattern is set to the length of the minimum recorded mark.

15. The optical recording medium of claim 1, wherein erasure pattern information including information about a power level of a first pulse of the erasure pattern and a power level of a last pulse of the erasure pattern is further recorded to the specific zone of the recording layer.

16. The optical recording medium of claim 15, wherein power levels of a first pulse and a last pulse forming the erasure pattern are recorded as one of 4 types, including a first type where power levels of the first pulse and last pulse are equal to a high erase power level, a second type where the power level of the first pulse is equal to a low erase power level and the power level of the last pulse is equal to the high erase power level, a third type where the power level of the first pulse is equal to the high erase power level and the power level of the last pulse is equal to the low erase power level, and a fourth type where the power levels of the first pulse and last pulse are equal to the low erase power level.

17. A method of recording data onto an optical recording medium, the method comprising:
generating a recording waveform having a recording pattern for high-speed recording; and
forming a first level of the data as a mark and a second level of the data as a space, using the generated recording waveform.

18. The method of claim 17, wherein the recording pattern is formed of recording multi-pulse trains including a first pulse, a multi-pulse train, and/or a last pulse, wherein power levels of the recording multi-pulse trains are equal to a high or low write power level, and a low write power level is higher than a bias power level for a last pulse of the recording multi-pulse trains.

19. The method of claim 18, wherein a power for an erasure pattern for data erasure has a predetermined DC level.

20. The method of claim 18, wherein a ratio of a time duration of the last pulse to a time duration of the multi-pulse train has a predetermined range with respect to a range of jitter allowable by a system.

21. A method of recording data onto an optical recording medium, the method comprising:
generating a recording waveform having a recording pattern and an erasure pattern with a multi-pulse train for high-speed recording; and
forming a first level of the data as a mark and a second level of the data as a space, using the generated recording waveform.

22. The method of claim 21 wherein the recording pattern is formed of a recording multi-pulse train including a first pulse, a multi-pulse train, and/or a last pulse, wherein power levels of the recording multi-pulse train are equal to a high or low write power level, and a low write power level is higher than a bias power level for a last pulse of the recording multi-pulse train.

23. The method of claim 22, wherein time periods of the recording multi-pulse train are controlled with respect to a timing window Tw within a range of 0.25-2.0 Tw.

24. The method of claim 23, wherein time periods of the recording multi-pulse train are equal to 1.0 Tw.

25. The method of claim 23, wherein time periods of the recording multi-pulse train are equal to 2.0 Tw.

26. The method of claim 22, wherein power levels of the multi-pulse train constituting the erasure pattern periodically change between at least two levels, a high erase power level Ppe and a low erase power level Pbe.

27. The method of claim 22, wherein a ratio of the time duration of the last pulse to a time duration of the multi-pulse train has a predetermined range with respect to a range of jitter allowable by a system.

28. The method of claim 22, wherein a minimum cooling time duration of the last pulse depends on the range of jitter allowable by a system, and a maximum cooling time duration of the last pulse depends on a length of a minimum recorded mark.

29. The method of claim 27, wherein the cooling time duration of the last pulse of the recording pattern is set to the length of the minimum recorded mark.

30. The method of claim 22, further comprising write power information about the generated recording waveform at a specific zone of a recording layer.

31. An apparatus for recording data onto an optical recording medium, the apparatus comprising:
a recording waveform generating circuit, which generates a recording waveform having a recording pattern for high-speed recording of the data; and
a pickup unit, which forms a mark or space by irradiating light onto the optical recording medium according to the generated recording waveform to record the data.

32. The apparatus of claim 31, wherein the recording pattern is formed of a recording multi-pulse train including a first pulse, a multi-pulse train, and/or a last pulse, wherein power levels of the recording multi-pulse train are equal to a high or low write power level, and a low write power level is higher than a bias power level for a last pulse of the recording multi-pulse train.

33. The apparatus of claim 32, wherein the recording waveform further comprises an erasure pattern formed of an erase multi-pulse train for data erasure, and the erase multi-pulse train has a high erase power level and a low erase power level and a low erase power level Pbe is set to be equal to a predetermined DC level of a general erase power, a high erase power level Ppe is set to be equal to the predetermined DC level, or the predetermined DC level is set between the high erase power level Ppe and the low erase power level Pbe.

34. The apparatus of claim 33, wherein a ratio of a time duration of the last pulse to a time duration of the multi-pulse train has a predetermined range with respect to a range of jitter allowable by a system.

35. The apparatus of claim 33, wherein a minimum cooling time duration of the last pulse depends on a range of jitter allowable by a system, and a maximum cooling time duration of the last pulse depends on a length of a minimum recorded mark.

36. The apparatus of claim 35, wherein the cooling time duration of the last pulse of the recording pattern is set to the length of the minimum recorded mark.

37. The apparatus of claim 32, wherein a power for the erasure pattern for data erasure has a predetermined DC level.

38. The apparatus of claim 37, wherein a ratio of the time duration of the last pulse to the time duration of the multi-pulse train has a predetermined range with respect to a range of jitter allowable by a system.

39. An optical recording medium comprising a recording layer wherein a low level of a write power for recording a pattern is set to be higher than a bias power level when data is recorded.

40. An optical recording medium comprising a recording layer wherein shapes of leading and trailing parts of a mark are prevented from being distorted by applying an erase power level to the optical recording medium in the shape of a pulse.

41. An optical recording medium comprising a recording layer wherein time durations of high and low levels of an erase power are controlled with respect to a timing window Tw having a range of 0.25 to 2.0 Tw, and data is recorded onto the optical recording medium while selecting time durations of high and low levels of the erase power suitable for thermal characteristics of the optical recording medium.

42. An optical recording medium comprising a recording layer wherein when time periods of recording multi-pulse trains and erase multi-pulse trains are equal to 2.0 Tw, respectively, a quality marked is formed by increasing an amount of incident light on the optical recording medium, without increasing a write power and an erase power.
